(19) United States
(12) Patent Application Publication
(10) Pub. No.: US 2019/0084882 A1
(43) Pub. Date: Mar. 21, 2019

(54) CONTROL OF TIME OF SETTING OF GEOPOLYMER COMPOSITIONS CONTAINING HIGH-CA REACTIVE ALUMINOSILICATE MATERIALS

(71) Applicant: The Catholic University of America, Washington, DC (US)

(72) Inventors: Weiliang GONG, Rockville, MD (US); Hui XU, Rockville, MD (US); Werner LUTZE, Chevy Chase, MD (US); Ian L. PEGG, Alexandria, VA (US)

(21) Appl. No.: 16/190,422

(22) Filed: Nov. 14, 2018

Related U.S. Application Data
(63) Continuation-in-part of application No. 15/597,227, filed on May 17, 2017.
(60) Provisional application No. 62/339,334, filed on May 20, 2016.
(60) Provisional application No. 62/599,068, filed on Dec. 15, 2017.
(60) Provisional application No. 62/703,295, filed on Jul. 25, 2018.
(60) Provisional application No. 62/721,021, filed on Aug. 22, 2018.

(51) Int. Cl. C04B 28/00; C04B 18/08; C04B 18/06; C04B 18/16; C04B 14/10; C04B 20/00; C04B 22/06; C04B 40/06

(52) U.S. Cl. CPC C04B 28/006; C04B 18/08; C04B 18/067; C04B 18/162; C04B 2103/22; C04B 20/0036; C04B 22/062; C04B 40/0658; C04B 14/106

(57) ABSTRACT

The present disclosure provides a geopolymer composition having a controllable setting time comprising: at least one reactive aluminosilicate; at least one retarder; and at least one alkali silicate activator solution.

### CROSS-REFERENCE TO RELATED APPLICATIONS

This application is a continuation-in-part of U.S. application Ser. No. 15/597,227 filed May 17, 2017, which claims benefit of priority to U.S. Provisional Patent Application No. 62/339,334 filed May 20, 2016. This application also claims benefit of priority to U.S. Provisional Patent Application No. 62/599,068, filed Dec. 15, 2017, U.S. Provisional Patent Application No. 62/703,295 filed Jul. 25, 2018 and U.S. Provisional Patent Application No. 62/721,021 filed Aug. 22, 2018. The entire content and disclosure of these patent applications are incorporated herein by reference in its entirety.

This application makes reference to the following applications: U.S. Provisional Patent Application No. 61/781,885 filed Mar. 14, 2013; U.S. patent application Ser. No. 14/193,001 filed Feb. 28, 2014 (now U.S. Pat. No. 9,919,974 issued Mar. 20, 2018); International PCT Application No. PCT/IB2014/059599 filed Mar. 10, 2014; and International PCT Application No. PCT/IB2017/052934 filed May 18, 2017. The entire contents and disclosures of these patent applications are incorporated herein by reference.

### BACKGROUND

### Field of the Invention

The disclosed invention relates generally to admixtures for geopolymer compositions. More particularly, it relates to retarding admixtures for efficient control of settings in a geopolymer compositions and systems which may be employed for specific applications.

### Background of the Invention

In general, geopolymers made with certain reactive High-Ca aluminosilicate set and harden very quickly due to instant formation of calcium silicate hydrate and calcium aluminosilicate hydrate gels. In engineering practice, geopolymers should have a reasonably long setting time. This means that concrete or mortar made using a pozzolanic binder should have a setting time long enough to permit transport and placement. However, it becomes uneconomic if the setting time is too long. Thus, improvements in proper control of the setting time by using a set retarder is crucial to successful applications of geopolymer materials in construction and building industries.

### SUMMARY

According to first broad aspect, the present disclosure provides a geopolymer composition having a controllable setting time comprising: at least one reactive aluminosilicate; at least one retarder; and at least one alkali silicate activator solution.

According to a second broad aspect, the present disclosure provides a method of making a geopolymer composition having a controllable setting time comprising: combining at least one reactive aluminosilicate, at least one retarder and at least one alkali silicate activator solution.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 illustrates Raman spectra of a sodium silicate activator solution that contain 0% to 5% barium chloride monohydrate BWOB according to one embodiment of the present disclosure.

FIG. 2 illustrates Raman spectra of co-precipitated silicate materials that contains 0.5%, 0.75, 0.875 and 1.0% barium chloride monohydrate BWOB according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “actual temperature” refers to the actual temperature of the air in any particular place, as measured by a thermometer.

For purposes of the present disclosure, the term “BWOB” refers “by weight of binder” which is generally recognized as the amount (in percent) of a material added to cement when the material is added based on the total amount of a specific binder or the blend of binders. In the case of geopolymeric materials, binders are typically pozzolanic materials called pozzolanic precursor which can be activated by alkaline solutions.

For purposes of the present disclosure, the term “cement” refers to a binder, a substance used for construction that sets, hardens, and adheres to other materials to bind them together. Seldom used on its own, cement may be utilized to bind sand and gravel (aggregate) together. Cement mixed with fine aggregate produces mortar for masonry, or with sand and gravel, produces concrete. Cements used in construction are usually inorganic, often lime or calcium silicate based, and can be characterized as either hydraulic or non-hydraulic, depending on the ability of the cement to hydrate in the presence of water.

For purposes of the present disclosure, the term “concrete” refers to a heavy, rough building material made from a mixture of broken stone or gravel, sand, cementing material, and water, that can be spread or poured into molds and that forms a stone-like mass on hardening. Some embodiments may include a composite material composed of fine and coarse aggregate bonded together with a fluid cement (cement paste) that hardens over time. Most frequently Portland cement may be utilized but sometimes other hydraulic cements may be used, such as a calcium aluminate cement. Geopolymers are considered to be a new type of cementing materials without Portland cement.

For purposes of the present disclosure, the term “geopolymer” refers to sustainable cementing binder systems without Portland cement. In a narrow term, geopolymers of the disclosed invention are related to inorganic polymers with a three-dimensional network structure similar to those of organic thermoset polymers. The backbone matrix of the disclosed geopolymers is an X-ray amorphous analogue of the framework of zeolites, featuring tetrahedral coordination of Si and Al atoms linked by oxygen bridges, with alkali metal cations (typically Na⁺ and/or K⁺) associated as charge balancers for AlO₄⁻. Geopolymers of the disclosed invention may be more widely regarded as a class of alkali-activated materials (AAM) composed up of alkali-aluminosilicate and/or alkali-alkali earth-aluminosilicate phases, as a result of the reaction of an solid aluminosilicate powder (term pozzolanic precursor) with an alkali activator.

For purposes of the present disclosure, the term “geopolymer composition” refers to a mix proportion consisting of pozzolanic precusors and alkali activator in solid or liquid form Additionally a geopolymer composition may further include fine and coarse aggregate, fibers and other admixtures depending on the application.

For purposes of the present disclosure, the term “mortar” refers to a workable paste containing fine aggregate used to bind building blocks such as stones, bricks, and concrete masonry units together, fill and seal the irregular gaps between them, and sometimes add decorative colors or patterns in masonry walls. In its broadest sense mortar includes pitch, asphalt, and soft mud or clay, such as used between mud bricks. Cement or geopolymer mortar becomes hard when it cures, resulting into a rigid structure.

For purposes of the present disclosure, the term “room temperature” refers to a temperature of from about 15° C. (59° F.) to 25° C. (77° F.).

For purposes of the present disclosure, the term “setting” refers to conversion of a plastic paste into a non-plastic and rigid mass.

For purposes of the present disclosure, the term “set time” or “setting time” refers to the time elapsed between the moment water (alkali activator solution) is added to the cement (pozzolanic precursor) to the time at which paste starts losing its plasticity (initial setting). Final setting time is the time elapsed between the moment the water (alkali activator solution) is added to the cement (pozzolanic precursor) to the time at which the paste has completely lost its plasticity and attained sufficient firmness to resist certain definite pressure.

For purposes of the present disclosure, the term “sparingly soluble in water” refers to a substance having a solubility of 0.1 g per 100 ml of water to 1 g per 100 ml of water. Unless specified otherwise, the term “sparingly soluble” and “sparingly soluble in water” are used interchangeably in the description of the invention below to refer to substances that are sparingly soluble in water.

For purposes of the present disclosure, the term “water insoluble” refers to a substance that has a solubility of less than 0.1 g per 100 ml of water.

### Description

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

Geopolymers are a class of alkali-activated binders with a three-dimensional network structure similar to those of organic thermoset polymers. The backbone matrix of geopolymers is an X-ray amorphous analogue of the framework of zeolites, featuring tetrahedral coordination of Si and Al atoms linked by oxygen bridges, with alkali metal cations (typically Na⁺ and/or K⁺) associated as charge balancers for AlO₄⁻. Nominally, the empirical formula of geopolymers can be presented as Mₙ[-(SiO₂)_{z}—AlO₂]ₙ.wH₂O where M represents the alkalis cation; z, the molar ratio of Si to Al (1, 2 or 3); and n, the degree of polycondensation. The dissolution of the reactive Low-Ca aluminosilicate source by alkaline hydrolysis consumes water and produces aluminate and silicate species. This first stage of the geopolymerization is controlled by the aptitude of the alkaline compound to dissolve the fly ash glass network and to produce small reactive species of silicates and aluminates:

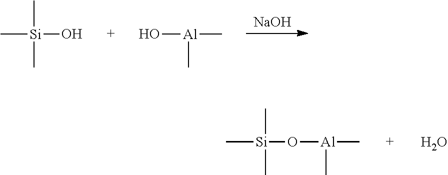

Once dissolved, the species become part of the aqueous phase, i.e., the activating solution, which already contains silicate. A complex mixture of silicate, aluminate and aluminosilicate species is thereby formed. The solution becomes more and more concentrated, resulting in the formation of an alkali aluminosilicate gel (AAS), as the species in the aqueous phase form large networks by poly-condensation:

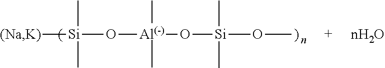

After gelation, the system continues to rearrange and reorganize, as the connectivity of the gel network increases, resulting in a three-dimensional aluminosilicate network that set and hardens during subsequent curing process.

Examples of these Low-Ca reactive aluminosilicates include metakaolin (MK), certain calcined zeolites, and low Ca Class F fly ash (Low-Ca FFA).

Metakaolin is an amorphous aluminosilicate pozzolanic material and its use dates back to 1962 when it was incorporated in concrete for the Jupia Dam in Brazil. It is a thermally activated aluminosilicate material with high pozzolanic activity comparable to or exceeded by the activity of fumed silica. It is generated by calcination of kaolinitic clay at 650° C. to 800° C. depending on the purity and crystallinity of the precursor clays. Alkali activation of metakaolin yields a typical AAS gel composition that will set and harden at ambient temperatures. The mechanical properties and microstructure of geopolymer strongly depend on the initial molar Si/Al ratio. Better strength properties have been reported for mixtures with SiO₂/Al₂O₃ ratios in the range of 3.0-3.8 with a molar M₂O/Al₂O₃ ratio of about one.

Fly ash is a fine, powdery substance that “flies up” from the coal combustion chamber (boiler) and is captured by emissions control systems, such as an electrostatic precipitator or fabric filter “baghouse,” and scrubbers. About 131 million tons of fly ash is produced annually and approximately 56 million tons of that fly ash is recycled. Worldwide, about 65% of the fly ash produced is disposed of in landfills or ash ponds. The burning of anthracite and bituminous coal typically produces Class F fly ash that contains less than 8% CaO. Fly ash is mainly comprised of glassy spherical particles. American Society for Testing and Materials (ASTM) C618 standard recognizes two major classes of fly ashes, Class C and Class F. The lower limit of (SiO₂+Al₂O₃+Fe₂O₃) for Class F fly ash (FFA) is 70% and that for Class C fly ash (CFA) it is 50%. High calcium oxide content makes Class C fly ashes, which possess cementitious properties leading to the formation of calcium silicate and calcium aluminate hydrates when mixed with water, without requiring alkali activation. U.S. Pat. No. 5,435,843 discloses an alkali activated Class C fly ash composition where the initial setting time of the cement is less than about 5 minutes. In general, Class F fly ashes have a maximum content of calcium oxide of about 18 wt. %, whereas Class C fly ashes generally have higher calcium oxide contents, such as 20 to 40 wt. %. Low-Ca FFA usually contains less than 8 wt. % of CaO. Low-Ca FFA based geopolymers usually set and harden very slowly and have a low final strength when cured at ambient temperatures (e.g., room temperature) but its reactivity increases with increasing curing temperature. In order to manufacture useful construction products, alkali activation of Low-Ca FFA requires high temperature curing. Alternatively, a more reactive aluminosilicate material such as ground granulated blast furnace slag (BFS) or metakaolin must be blended to manufacture a geopolymer product that sets and hardens at ambient temperatures.

Ground granulated blast furnace slag is another type of reactive aluminosilicate material that is rich in alkali-earth oxides such as CaO and MgO. It is a glassy granular material that varies, from a coarse, popcorn-like friable structure greater than 4.75 mm in diameter to dense, sand-size grains. Grinding reduces the particle size to cement fineness, allowing its use as a supplementary cementitious material in Portland cement-based concrete. Blast furnace slag is essentially a calcium aluminosilicate glass, typically containing 27-38% SiO₂, 7-12% Al₂O₃, 34-43% CaO, 7-15% MgO, 0.2-1.6% Fe₂O₃, 0.15-0.76% MnO and 1.0-1.9% by weight. Blast furnace slag is usually classified into three grades, i.e., 80, 100 and 120 by ASTM C989-92. Furthermore, ultrafine blast furnace slag is even more reactive compared to BFS 120. For example, MC-500® Microfine® Cement (de neef Construction Chemicals) is an ultrafine furnace slag with particle sizes less than about 10 μm and a specific surface area of about 800 m²/kg. Since BFS is almost 100% glassy, it is generally more reactive than most fly ashes. Alkali activation of BFS yields essentially calcium silicate hydrate (CSH) and calcium aluminosilicate (CASH) gels. It is well known that geopolymers made by alkali activation of BFS usually set and harden& very quickly even at ambient temperature, resulting in much higher ultimate strength than geopolymers made with low Ca class F fly ash. For some compositions, the time of initial set is less than 60 minutes making it difficult to mix, place and finish. Alkali activated slag has been found to have some superior properties as compared to Portland cement concrete such as low hydration heat, high early strength and excellent durability in an aggressive environment: A survey of the published literature showed that this binder system has some serious problems such as rapid setting and high drying shrinkage.^{2,3} These problems must be resolved before it can be used in commercial practice.

Recently, use of lignite and subbituminous coals has substantially increased and a significant percentage of the coal reserves in the US produce fly ash that contains considerable amounts of CaO. The fly ash containing high CaO contents (High-Ca FFA), e.g., greater than 8 wt. % and less than 20 wt. % may still be classified as type F according to ASTM C-618. The setting times of fly ash based geopolymers decrease exponentially as the CaO content increases and however compressive strength increases with increasing CaO.⁴ Disclosed embodiments found that flash setting might occur in fresh geopolymers made with High-Ca FFA containing 12.2 wt. % CaO. Geopolymers made with CFA with CaO more than 20% usually set within 36 minutes and flash set is very common, e.g., a few minutes.⁵ Apparently, geopolymers made with High-Ca FFA (e.g., greater than 8% CaO) and CFA require appropriate control of setting to manufacture useful construction products.⁶ Alkali activation of High-Ca FFA yields hydrated products such as CSH and CASH, together with the alkali aluminosilicate gel. Set times of geopolymers depend as well on characteristics of the alkali activator solution such as molar alkali concentration, molar SiO₂/M₂O (M=Na, K) and water to binder ratio (w/b). For example, set times decrease with increasing molar alkali hydroxide concentration and molar SiO₂/M₂O (M=Na, K) but increases with increasing w/b. On the contrary, compressive strength of a hardened geopolymer increases with increasing molar alkali hydroxide concentration and molar SiO₂/M₂O (M=Na, K).

Class C fly ash bears some similarities to blast furnace slag. Both are calcium alumino-silicate glasses. These pozzolanic materials are termed reactive alkali-earth aluminosilicates, or High-Ca reactive aluminosilicate. In addition to BFS and CFA, High-Ca FFA, vitreous calcium silicate (VCAS), and clinker kiln dust (CKD) fall into this category. VCAS is a waste product of fiberglass production. In a representative glass fiber manufacturing facility, typically about 10-20 wt. % of the processed glass material is not converted into the final product and is rejected as by-product or waste VCAS and sent for disposal to a landfill. VCAS is 100% amorphous and its composition is very consistent, mainly including about 50-55 wt. % SiO₂, 15-20 wt. % Al₂O₃, and 20-25 wt. % CaO. Ground VCAS exhibits pozzolanic activity comparable to silica fume and metakaolin when tested in accordance with ASTM C618 and C1240. CKD is a by-product of the manufacture of Portland cement, and is an industrial waste. Over 30 million tons of CKD are produced worldwide annually, with significant amounts put into landfills. Typical CKD contains about 38-64 wt. % CaO, 9-16 wt. % SiO₂, 2.6-6.0 wt. % Al₂O₃, 1.0-4.0 wt. % Fe₂O₃, 0.0-3.2 wt. % MgO, 2.4-13 wt. % K₂O, 0.0-2.0 wt. % Na₂O. 1.6-18 wt. % SO₃, 0.0-5.3 wt. % and has 5.0-25 wt. % LOI. CKD is generally a very fine powder (e.g., about 4600-14000 cm²/g specific surface area). Additional formation of CSH gel, ettringite (3CaO.Al₂O₃.3CaSO₄.32H₂O), and/or syngenite (a mixed alkali-calcium sulfate) will occur during alkali activation.

In general, geopolymers made with alkali-activation of these reactive High-Ca aluminosilicate set and harden very quickly due to instant formation of calcium silicate hydrate and calcium aluminosilicate hydrate gels. In engineering practice, geopolymers should have a reasonably long setting time. This means that concrete or mortar made using a pozzolanic binder should have a setting time long enough to permit transport and placement. However, it becomes uneconomic if the setting time is too long. According to disclosed embodiments, proper control of the setting time by using a set retarder is crucial to successful applications of geopolymer materials in construction and building industries.

Control of set times may be achieved by appropriately formulating an activator solution composition for High-Ca aluminosilicate based geopolymers. For example, a large w/b and a low concentration of alkali silicate may yield a geopolymer paste with a sufficiently long set time or workability. However, the performance of the hardened product is usually affected significantly and a much lower strength and large dry shrinkage are expected. In recent years, a diverse selection of admixtures has been used to retard the setting in alkali-activated cements or geopolymers, although their retarding efficiencies vary widely.³ U.S. Pat. No. 5,366,547 discloses a method to use a phosphate additive to retard the set time of sodium hydroxide activated blast furnace slag. Examples of a phosphate retarder include sodium metaphosphate, sodium polyphosphate, potassium metaphosphate, and potassium polyphosphate. The retarding effect of these phosphate additives may vary when the sodium silicate solution is used to activate BFS or other types of High-Ca aluminosilicates. Kalina et al.⁷ used Na₃PO₄ to retard setting of sodium silicate activated blast furnace slag. Solid sodium phosphate was blended with BFS and then mixed with the sodium silicate activator solution. Compressive strength was affected (decreased) significantly when a high dosage of the retarder was applied to achieve a long set time or workable time. Chang⁸ and Chang et al.⁹ concluded that using solely phosphoric acid extended the setting time of alkali-activated slag after reaching a critical concentration, but reduced the compressive strength at an early age. It was assessed that Ca²⁺ ions released during the dissolution of blast furnace slag in a highly alkaline solution bond to the phosphate anion from the retarder. The formation of calcium dihydrogen-, later hydrogen phosphate structures results in a deficiency of calcium ions in solution, which in turn prevents CSH and CASH from nucleation and the growth. Thus, initial setting time is prolonged.

The efficiency of certain retarders commonly used for Portland cement varies in geopolymers. Most set retarding admixtures, efficient in Portland cement, may not work in highly alkaline geopolymer systems. Wu et al.¹⁰ observed that potassium or sodium tartrate did not show any effect on the initial setting time of alkali-activated slag, but slightly shortened the final setting time. Rathanasak et al.¹¹ found that sucrose and gypsum that work well in Portland cement did not extend set times of sodium silicate activated High-Ca FFA. Brought et al.¹² investigated the retarding effect of NaCl on set times of sodium silicate activated slag systems. The addition of NaCl significantly retarded both setting and strength development at high doses, but at low doses, i.e., 4% or less by weight of slag, NaCl acted as an accelerator. In another sodium silicate activated slag system,¹³ little effect of NaCl on setting time was observed up to 20% addition by weight of the binder (BWOB), beyond which point setting was retarded. However, addition of such a large amounts of chloride in reinforced geopolymer concrete may significantly accelerate the rebar corrosion and thus reduce the service time.

The use of borates as retarders for Portland cement is also very well known. However, Nicholson et al.¹⁴ reported that borates added to alkali-activated fly ash (class C) did not influence the setting behavior; conversely, the strength of the binders was negatively affected by a high amount of borates. U.S. Pat. No. 4,997,484 discloses an alkali hydroxide activated Class C fly ash geopolymer composition (without containing soluble silicate). The geopolymer compositions exhibit a rapid strength gain, e.g., 1800 to 4000 psi after curing at 73° F. for 3-4 hours, though borax is used as a retarder. The boron retarder was not efficient in retarding setting of alkali-activated CFA geopolymer. Both U.S. Pat. Nos. 7,794,537 and 7,846,250 disclose certain chemical compounds as retarders that are well known for Portland cement and geopolymer. The geopolymer compositions are either MK or FFA based for oil field applications or carbon dioxide storage. These compounds, which retard thickening of the well cementing grout at elevated temperatures, e.g., 85° C., includes borax (Na₂B₄O₇.10H₂O), boric acid, sodium phosphate salt, and lignosulfonate.

US Pat. Appl. No. US 2011/0284223 discloses compositions and methods for well cementing application that employ organic compounds to retard thickening of geopolymeric systems at elevated temperatures. The geopolymer compositions are not new and have been disclosed in the prior art and extensively studied in the literature. The preferred compounds as a retarder include aminated polymer, amine phosphonates, quaternary ammonium compounds and tertiary amines. While geopolymer composition itself is not unique, however, the impact of these retarders on the hardened properties such as compressive strength was not previously developed \communicated.

Chinese Pat. CN 102249594B discloses complex retarders to retard set times of alkali activated blast furnace slag. The complex retarder is composed of sodium chromate, heterocyclic amino acid and silicone surfactant. Chinese Pat. CN 1118438C discloses a complex retarder consisting of potassium chromate, sugar and phenol for sodium silicate activated slag. The initial setting can be adjusted between 1 hour and 70 hours. However, the retarder may not be desirable as chromate is a highly mobile, easily migrating, toxic anionic species and poses the risk to contaminate the environment. Chinese Pat. Appl. CN 101723607A discloses soluble zinc salts to retard set times of sodium silicate activated blast furnace slag. These zinc salts include nitrate, sulfate and chloride. Chinese Pat. Appl. CN 1699251A and CN 100340517C disclose barium salt as a retarder for alkali-activated carbonite/blast furnace slag. Either zinc or barium salt is dissolved in water and added to blast furnace slag. Then the alkaline activator solution is added to the mixture. Alternatively, the salt powder is ground with blast furnace slag. The activator solution is then mixed with the solid blend.

Unfortunately, most retarders in the prior art were developed only for alkali-activated slag. It is well know that the efficiency of retarders significantly depend on the binder compositions. A retarder efficient in Portland cement and alkali-activated slag does not necessarily work well in geopolymer systems such as made of High-Ca FFA, CFA, or the blend of Low-Ca FFA and BFS.

The methods disclosed in the prior art employ mostly two important mechanisms to retard setting times of alkali-activated slag. Retarders are added to chelate and/or precipitate Ca²⁺ released to prevent Ca²⁺ from reacting with silicate species that are already present in the alkali activator solution. In another method, retarders are added to form directly bonded protection layers on the surfaces of anhydrous blast furnace slag particles and thereby reducing their ability to dissolve in the highly alkaline solution. These adhered layers could be either adsorbed species or insoluble calcium salts that precipitate and adhere onto the surfaces. Here this method is termed to be “Protecting Layer.” Chinese Pat. CN 102249594B discloses that silicone surfactant is adsorbed on the surfaces of blast furnace slag particles, chargers are introduced, resulting in repulsion to reduce the migrating rate of Ca²⁺ and/or reduce the electrostatic attraction of silicate anions, thereby preventing CSH gel formation. Ca²⁺ cations released during dissolution of blast furnace slag in a highly alkaline environment bond to the phosphate anions from the phosphate retarder, e.g., Na₃PO₄. Formation of insoluble calcium phosphate compounds reduces available Ca²⁺ and thus causes nucleation and growth of the CSH phase to be poisoned, and thus set times are extended.⁷ Boron compounds dissolved in alkaline solution form tetra hydroxyl borate that in turn reacts with Ca^{2±}. The precipitated calcium borate (e.g., Ca(B[OH]₄)₂ H₂O) partially or fully covers the surface of blast furnace slag particles. The presence of such impermeable calcium borate layers thus prevents further dissolution of blast furnace slag particles in the alkaline solution.¹⁵ Soluble zinc salts are transformed into a calcium zincate phase (e.g., CaZn₂(OH)6.H₂O), which partially or completely covers blast furnace slag grains and thus passivates them against further hydration or alkali activation.^{16,17} US Pat. Appl. No. US 20160060170 discloses geopolymer compositions with a nanoparticle retarder to control set times. The reactive aluminosilicates include metakaolin, fly ash or rice husk ash. Reactive aluminosilicate particles are coated with nanoparticles such as halloysite nanotube or kaolin nanoclay particles before mixing with sodium silicate activator solution. The nanoparticle coating is to retard geopolymerization reaction. The barium salt solution is premixed with blast furnace slag/carbonatite powders. Because the surfaces of blast furnace slag particles are negatively charged in water, Ba²⁺ cations tend to adsorb on the surfaces of the slag grains. Upon exposure to the alkali silicate solution, insoluble barium precipitates form a thin film on the slag grains and thus prevent the slag from contact with the alkaline solution (Chinese Pat. Appl. CN 1699251A).

When the formation of protection layers on the surfaces of pozzolanic particles is used to retard set times of alkali activated materials, the solution of the metal salts such as barium nitrate must be mixed with the pozzolanic particles before mixing with an alkaline silicate solution to improve the coverage of the protective coating.

Disclosed embodiments provide a new method using metal salts to retard set times of alkali activated materials or geopolymers. Fast setting of alkali activated High-Ca reactive aluminosilicates is related to the formation of CSH and/or CASH gels at early curing time. Ca²⁺ cations are released during dissolution of High-Ca reactive aluminosilicate particles and the cations react almost instantly with silicate anions present in the alkaline solution. Control of setting can be achieved through the methods in the prior art, e.g., through removal of Ca²⁺ ions in the alkaline solution and/or formation of protecting layers on the surfaces of pozzolanic particles. Control of setting can be also achieved by controlling availability of silicate species for nucleation and growth of CSH and/or CASH gels. For example, in the disclosed method for well cementing geopolymers¹⁸, powdered alkali silicate glass is used. The geopolymer paste contains little silicate species in the early curing time. The powdered alkali silicate glass dissolves and releases silicate species at a controlled rate during the early curing time and thus thickening and setting times are extended. However, this method yields hardened geopolymers that are not appropriate in the application for construction materials where strength over 30 MPa is required. Alternatively, metal salts (e.g., barium chloride) are dissolved in water and then the resulting solution is blended with the alkali silicate solution before mixing with the dry ingredients in a mixer. These metal salts such as barium chloride hydrolyze in the alkaline solution and during hydrolysis silicate anions are co-precipitated, leaving an activator solution depleted in silicate species. The extent of metal-silicate interactions depends on the molar metal/Si ratio that determines efficiency of retardation. The co-precipitated silicate re-dissolves slowly and becomes available for geopolymerization and/or formation of CSH and/or CASH gels during the subsequent curing process. Thus, the set time is extended.

The disclosed method uses much less barium salts to reach comparable set times as with the “Protecting Layers” method disclosed in Chinese Pat. Appl. CN 101723607A, CN 1699251A and CN 100340517C where metal salt solution must be premixed with the solid, i.e., the blast furnace slag to achieve a protective coating on the pozzolanic grains. For example, at least 2% BWOB zinc salts take the retarding effect in the sodium silicate activated blast furnace slag. At least 4% BWOB barium salts take retarding effect in sodium silicate activated blast furnace slag/carbonatite. A higher dosage of retarders is needed to achieve better coverage of the protecting layers and however, usually causes significant reduction of compressive strength of a hardened product. Besides, the extent of the coverage of the protecting layers depends significantly on the surface charge of pozzolanic particles. Though the surface charge of blast furnace slag can be negative, the surface charge for fly ash can be positive in the solution. Therefore, with the “Protecting Layers” method, the efficiency of the retarding effect may differ significantly among different reactive aluminosilicate sources.

Thus, disclosed embodiments provide efficient inorganic retarding admixtures to regulate thickening and setting times of a geopolymer composition that can be applied as a well cementing grout, mortar and concrete.

Other embodiments, described herein, provide geopolymer compositions whose set times can be varied by an inorganic retarder. A geopolymer composition comprises: (i) at least one Low-Ca Class F fly ash having less than or equal to 8 wt. % of calcium oxide; (ii) at least one High-Ca aluminosilicate selected from the group of blast furnace slag, Class C fly ash, vitreous calcium silicate, and kiln dust; (iii) a retarding solution; and (iv) an aqueous alkali silicate activator.

The disclosed retarder solution is made by dissolving at least one soluble metal salt in water where at least one soluble metal salt is selected from barium chloride, barium chloride dihydrate, barium nitrate, barium nitrite, barium metaborate monohydrate, barium nitrate hydrate, zinc nitrate, zinc chloride, zinc sulfate, lead chloride, lead nitrate, strontium chloride, strontium nitrate and strontium sulfate. Barium chloride and barium nitrate are preferred.

In one embodiment, at least one metal salt is dissolved in the retarder solution and the retarder solution contains about 0.1 to about 10% metal salts BWOB. In one embodiment, the metal salt is barium chloride dihydrate. The dosage of barium chloride dihydrate is from about 0.10 to about 5% BWOB, and more preferably from about 0.5% to about 2.5% BWOB.

In one embodiment, a soluble barium salt is dissolved in water. The retarder solution is mixed with an alkali silicate activator solution before mixing the activator solution with all other ingredients. In another embodiment, the retarder solution and the activator solution are added separately at the time when mixing with the dry ingredients. The alkali silicate activator solution may comprise metal hydroxides and metal silicates wherein the metal is potassium, sodium or combinations of both.

A disclosed embodiment provides a geopolymer composition including: (i) at least one High-Ca aluminosilicate selected from the group of BFS, CFA, vitreous calcium silicate, and kiln dust; (ii) a retarder solution; and (iii) an alkali silicate solution.

In one disclosed embodiment, a geopolymer composition includes (i) at least one High-Ca aluminosilicate selected from the group of BFS, CFA, vitreous calcium silicate, and kiln dust; (ii) metakaolin; (iii) a retarder solution; and (iv) an alkali silicate solution.

In one disclosed embodiment, the geopolymer composition further includes fine and/or coarse aggregates, superplasticizer or fiber to manufacture mortar and concrete for construction applications.

One disclosed embodiment provides high performance and ultrahigh performance concrete compositions whose set times can be regulated by an inorganic retarder. High performance and ultrahigh performance concrete compositions comprise: (i) Blast furnace slag; (ii) Metakaolin; (iii) a retarding solution; and (iv) an aqueous alkali silicate activator, (v) at least one aggregate; and (vi) at least one micron/submicron filler.

An objective of the present disclosure is to provide an effective retarding admixture to regulate setting times of a geopolymer composition that can be applied as well cementing, mortar and concrete. In particularly, the present disclosure provides an efficient retarding method to control setting of geopolymer systems containing High-Ca FFA or High-Ca aluminosilicate.

Low-Ca Fly Ash Based Geopolymers

Low-Ca FFA based geopolymers set and harden very slowly and have a low final strength if cured at low temperatures (e.g., room temperature) due to the fly ash's low reactivity in the alkaline solution. “Reactivity” is herein defined as the relative mass of a binder pozzolan that has reacted with an alkaline solution. Fly ashes with smaller particle sizes are usually more reactive, such as ultrafine fly ash (UFFA) with a mean particle size of about 1 to 10 μm. UFFA is carefully processed by mechanically separating the ultrafine fraction from the parent fly ash. UFFA can also reduce the w/b ratio for a desirable workability, e.g., slump and yields a hardened geopolymer with better performance. Coal gasification fly ash is discharged from coal gasification power stations, usually as SiO₂-rich, substantially spherical particles having a maximum particle size of about 5 to 10 μm. To make use of less reactive fly ashes, a second binder that is much more reactive is required to produce settable geopolymer products at ambient temperatures.

Alkali activation of metakaolin yields a typical geopolymer gel that possesses a reasonably long set time, e.g., 2 to 6 hours. When metakaolin is blended, the resulting geopolymer composition may not require a retarding admixture. In contrast, alkali activation of BFS, CFA, CKD or VCAS yields essentially CSH and/or CASH gels. Quick precipitation of CSH and/or CASH shortens setting times and increases the rate of strength gain as well as the final strength of the product. When the second binder is a High-Ca aluminosilicate pozzolan, the setting behavior of the resulting geopolymer system will be significantly modified. Set times of the fly ash-based geopolymer usually decrease exponentially with increasing the amount of blended High-Ca aluminosilicate pozzolans such as BFS, particularly when an alkaline activator solution with a high molar alkali hydroxide and a high molar SiO₂/M₂O (M=Na, K) is used to manufacture useful geopolymer products. Thus, appropriate control of setting becomes necessary for practical applications.

In one embodiment, the Low-Ca FFA can be a fly ash which comprises less than or equal to about 8 wt. % of calcium oxide. The classification of fly ash is based on ASTM C618, which is generally understood in the art. In one embodiment, the Low-Ca FFA comprises less than or equal to about 5 wt. % of calcium oxide. In one embodiment, the fly ash should contain at least 65 wt. % amorphous aluminosilicate phase and have a mean particle diameter of 60 μm or less, such as 50 μm or less, such as 45 μm or less, such as 30 or less. In one embodiment, the Low-Ca FFA has a Loss On Ignition (LOI) less than or equal to 5%. In one embodiment, the Low-Ca FFA has a LOI less than or equal 1%.

One embodiment described herein provides geopolymer compositions whose set times can be regulated by an inorganic retarder. A Low-Ca FFA based geopolymer composition comprises: (i) at least one Low-Ca Class F fly ash having less than or equal to 8 wt. % of calcium oxide; (ii) at least one High-Ca aluminosilicate selected from the group of blast furnace slag, Class C fly ash, vitreous calcium silicate, and kiln dust; (iii) a retarding solution; and (iv) an aqueous alkali silicate activator. The retarder solution is made by dissolving a soluble metal salt in water where a soluble metals salt is selected from barium chloride, barium chloride dehydrate, barium nitrate, barium nitrite, barium metaborate monohydrate, barium nitrate hydrate, zinc nitrate, zinc chloride, zinc sulfate, strontium chloride, strontium nitrate and strontium sulfate. Soluble barium salts are preferred.

In one embodiment, the Low-Ca FFA based geopolymer compositions further include metakaolin; in one embodiment, the geopolymer compositions further include fine and coarse aggregates to manufacture concrete products.

High-Ca Aluminosilicate-Based Geopolymers

Alkali activation of High-Ca aluminosilicate pozzolans usually yields instantly CSH and/or CASH gels upon exposure to highly alkaline solution, resulting in very short setting times. Without proper control of set times, these geopolymer materials could not be used for manufacturing useful products. Examples of these High-Ca aluminosilicates include High-Ca FFA, CFA, BFS, VCAS, bottom ash and clinker kiln dust (CKD).

One embodiment provides a High-Ca aluminosilicate based geopolymer composition including: (i) at least one High-Ca aluminosilicate selected from the group of High-Ca FFA, BFS, CFA, vitreous calcium silicate, and kiln dust; (ii) a retarder solution; and (iii) at least one alkali silicate solution.

In one embodiment, the High-Ca aluminosilicate is a High-Ca FFA; In one embodiment, the High-Ca aluminosilicate is BFS; and in another embodiment, the High-Ca aluminosilicate is CFA.

In one embodiment, the High-Ca aluminosilicate based geopolymer composition further includes at least one Low-Ca aluminosilicate pozzolan selected from the group: Low-Ca FFA and metakaolin. In one embodiment, a High-Ca aluminosilicate based geopolymer composition further includes fine and coarse aggregates to manufacture concrete products. In one embodiment, the geopolymer compositions further include fine and/or coarse aggregates to manufacture concrete products.

High Performance and Ultrahigh Performance Concrete

U.S. Pat. No. 9,090,508 discloses geopolymeric compositions for high performance and ultrahigh performance concrete. To achieve high and ultrahigh performance of a geopolymer product, very reactive aluminosilicate materials must be used as the binder, such as metakaolin and blast furnace slag; the w/b ratios much be small, e.g., near minimum; the packing density of particulates must be high to minimize the product's porosity and no coarse aggregates greater than 10 mm should be used to favor homogeneity. Therefore, set times of fresh concretes are relatively short particularly when a large amount of blast furnace slag is used in the formulations. The compositions disclosed in U.S. Pat. No. 9,090,508 are essentially blast furnace slag/metakaolin based binary geopolymers.

One embodiment described herein provides high performance and ultrahigh performance concrete compositions whose set times can be regulated by an inorganic retarder. High performance and ultrahigh performance concrete compositions comprise: (i) Blast furnace slag; (ii) Metakaolin; (iii) a retarding solution; and (iv) an aqueous alkali silicate activator, (v) at least one aggregate; and (vi) at least one micron/submicron filler.

Methods of Retarder Placement

The retarder solution is prepared by dissolving at least one soluble metal salt in water where at least one soluble metals salt is selected from barium chloride, barium chloride dehydrate, barium nitrate, barium nitrite, barium metaborate monohydrate, barium nitrate hydrate, zinc nitrate, zinc chloride, zinc sulfate, lead chloride, lead nitrate, strontium chloride, strontium nitrate and strontium and strontium sulfate. Any soluble metal salt that hydrolyzes in the alkaline solution and is able to co-precipitate silicate species that are present originally in the alkali silicate activator solution could be used as an inorganic retarding admixture. The retarding effect depends on the type of metals as well as dosage. Metal-silicate interactions are expected to increase with increasing dosage or molar metal to silicate ratio. The metal-silicate interactions should be not excessive. If the interactions are overwhelming, release of silicate species to the geopolymer system will be greatly hindered during subsequent curing process and thus the early compressive strength of the product will be affected significantly. Among all these metal salts, barium salts are preferred.

In one embodiment, at least one metal salt is dissolved in water. The retarder solution is mixed with an alkali silicate activator solution before mixing of all the ingredients. The alkali silicate activator solution combined with the retarder solution is poured into the mixer containing all the dry ingredients. In another embodiment, the retarder solution and the activator solution are added separately at the time when mixing with the dry ingredients to manufacture geopolymer products.

In one embodiment, the retarder solution is mixed with an alkali silicate activator solution for approximately 30 minutes before mixing with all other ingredients. In another embodiment, the retarder solution is mixed with an alkali silicate activator solution for approximately 10 minutes before mixing of all the ingredients. In another embodiment, the retarder solution is mixed with an alkali silicate activator solution for approximately 24 hours before mixing of all the ingredients. In another embodiment, the retarder solution is added to the concrete during mixing in a ready mix truck. In this case, the retarder solution serves as a set brake to prevent the mixing concrete from hardening in a ready mix truck during transportation to the job site, e.g., in an emergency.

In one embodiment, at least one metal salt is included in the retarder solution and the retarder solution contains about 0.1 to about 10% metal salts BWOB. In one embodiment, the metal salt is barium chloride dihydrate. The dosage of barium chloride dihydrate is from about 0.10 to about 5% BWOB, and more preferably from about 0.5% to about 2.5% BWOB.

In one embodiment, the metal salt is barium metaborate monohydrate; in one embodiment the retarder solution contains barium chloride dihydrate and zinc nitrate; in one embodiment the retarder solution contains strontium nitrate and zinc chloride.

Retarding Mechanism

The following examples will illustrate the mechanism for retarding set times of geopolymers of the present disclosure.

In accordance with disclosed embodiments, a new method is provided to use metal salts to control set times of alkali activated materials or geopolymers by controlling release of silicate species in the activator solution that are available for nucleation and growth of CSH and/or CASH gels at early curing time. Select embodiments conducted experiments to study the co-precipitation process of silicate with hydrolyzed barium chloride in the sodium silicate activator solution by Raman Spectroscopy. In one series of testing, Raman spectra of supernatant liquids and the precipitates were monitored with increasing dosage of barium chloride after mixing barium chloride dehydrate solution with the sodium silicate solution for 0.5 hours. In the second series of testing, the combined solutions of barium chloride and sodium silicate solutions were mixed and aged for 0.5, 2 and 24 hours, respectively at a fixed dosage of barium chloride dihydrate. Then the spectra of the supernatant liquid of these barium chloride/sodium silicate solutions were recorded.

Sodium hydroxide beads (99% purity) were dissolved in DI water and combined with Type Ru sodium silicate solution from PQ Corp to prepare a sodium silicate activator solution. Barium chloride dehydrate (99% purity) was dissolved in DI water separately. The compositions of the activator solutions are shown in Table 1. Molar concentration of NaOH was fixed at 5 and mass ratio of SiO₂/Na₂O was 1.25 throughout Examples 1 to 4. The activator solution used for testing was a part of a High-Ca FFA geopolymer composition and dosages of barium chloride dehydrate were expressed as by weight of the fly ash binder.

TABLE 1

| | | Molar | Mass | Retarder | Molar |
|---|---|---|---|---|---|
| Example# | Sample ID | NaOH | SiO₂/Na₂O | BWOB | Ba/Si |
| #1 | RM-BC00 | 5.0 | 1.25 | 0.0% | 0.00 |
| #2 | RM-BC0.875 | 5.0 | 1.25 | 0.875% | 0.04 |
| #3 | RM-BC2.5 | 5.0 | 1.25 | 2.5% | 0.12 |
| #4 | RM-BC5.0 | 5.0 | 1.25 | 5.0% | 0.23 |

A single grating spectrograph—notch filter micro-Raman system was used to gather the Raman spectra. A Melles-Griot Model 45 Ar⁺ laser provided the 5145 Å wavelength incident light that was directed through a broad band polarization rotator (Newport Model PR-550) to the laser microscope that guided the laser light to the precipitated solids or the solution in a 25 ml transparent vial through a long working distance Mitutoyo 10 microscope objective. The laser light power was approximately 22 mW at the sample. The scattered light was directed through an analyzer polarizer and the scattered light proceeded through a 150 μm aperture, and then to holographic notch and super-notch filters (Kaiser Optical Systems). The spectrograph used a 1200 gr/mm grating (Richardson Grating Laboratory). The incident slits of the JY-Horiba HR460 spectrograph were set to 6 cm⁻¹ resolution to collect spectra from 50 to 1600 cm⁻¹. The spectrograph was frequency calibrated using CC14, so that the recorded frequencies are accurate to within ±1 cm⁻¹. Parallel-polarized (VV) spectra were collected where the incident laser light was vertically polarized.

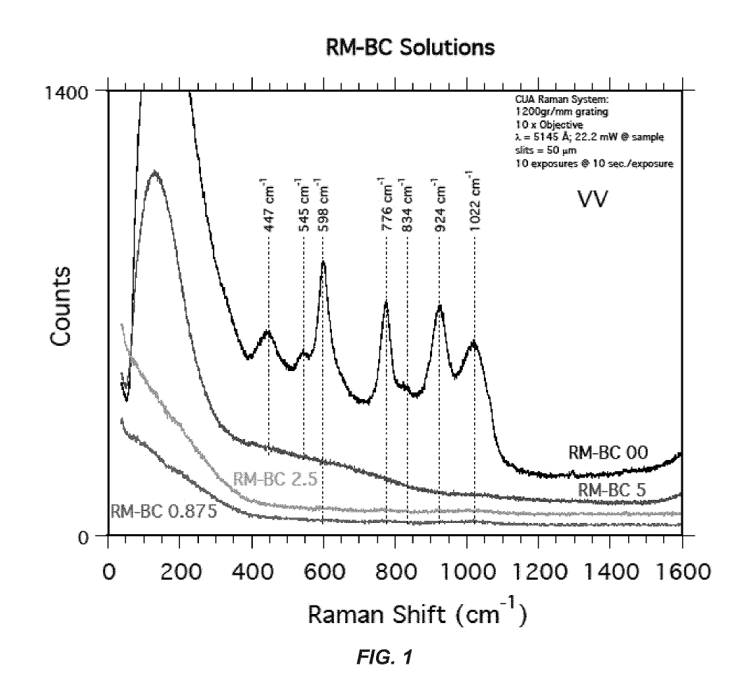

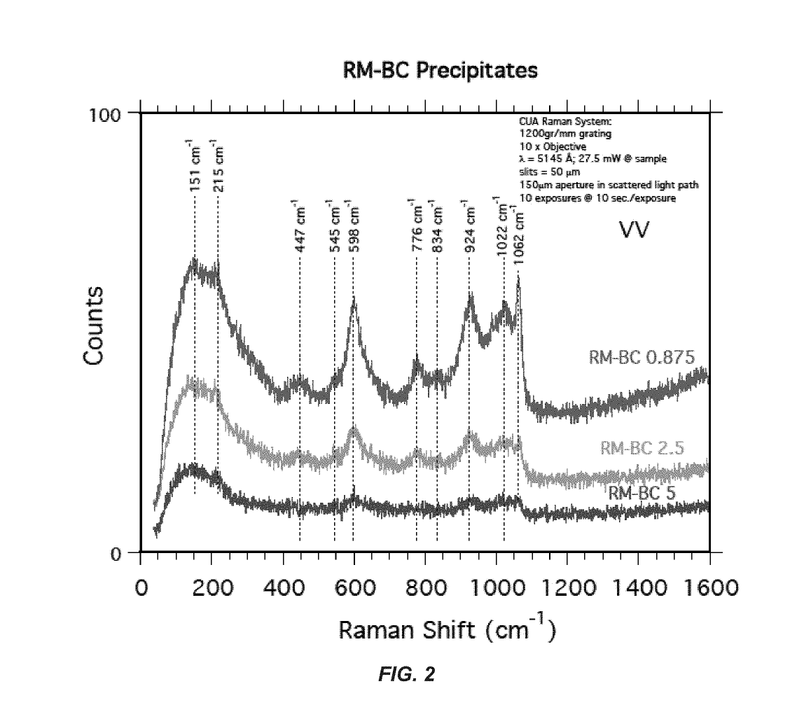

The assignments of Raman vibrations are provided in Table 2. The assignments were made according to Halasz et al.^{19,20} The results are presented in FIG. 1 for the supernatant solution and FIG. 2 for the precipitated solids.

TABLE 2

| Frequencies | | Associated |
|---|---|---|
| (cm⁻¹) | Assignments | species |
| 1062 | Related to Si—O(x) stretching | Q³ |
| 1022 | vₐₛ (x)O—Si—O(x) [x = H or -charge] | Q² |
| 924 | vₛ (H)O—Si—O(Na) | Q¹ |
| 834 | vₛ (Na)O—Si—O(Na) | Q⁰ |
| 776 | δₐₛ (H)O—Si—O(H) | Q⁰ |
| 606 | δₐₛ (Na)O—Si—O(Na) | 3-fold ring |
| 545 | — | 3-fold ring |
| 447 | δₛ (x)O—Si—O(x) [x = Na, H or | 4- or 6-fold ring |
| | -charge] | |

FIG. 1 presents Raman spectra of the supernatant samples of the sodium silicate solutions after mixing with barium chloride solution for 0.5 hours at four dosages of barium chloride dehydrate. The spectrum for the activator solution without retarder (RM-BC-0) shows clearly that the activator solution is dominated by the Q⁰, Q¹, and Q² type silicate species. The Q⁰ type silicate species is fully dissociated (FIG. 1). All the supernatant solutions for the samples with barium chloride dihydrate (Table 1) contain practically no silicate species, even at a very low dosage with a molar Ba/Si of 0.04 (RM-BC 0.875). This suggests that almost all silicate originally present in the activator solution co-precipitated with barium hydroxide when the barium chloride solution was mixed with the alkaline sodium silicate activator solution. Because the silicate species precipitates as a barium silicate complex, the concentration of soluble silicate available for geopolymerization is very low during early curing time. Limited availability of silicate species prevents CSH and/CASH gel from nucleation and growth, thus results in a delay in time of setting.

FIG. 2 presents Raman spectra of the co-precipitated solids after mixing with barium chloride solution with the activator solution for 0.5 hours at three dosages of the retarder. The co-precipitated sample with the lowest dosage of the retarder (RM-BC 0.875) shows a sharp Raman spectrum pattern where a new vibration band occurs at 1062 cm⁻¹ in addition to the bands associated with the Q⁰, Q¹ and Q² type silicate species. The 1062 cm⁻¹ band can be assigned to the Q³ silicate species. Comparing this Raman spectrum with the one for the activator solution without the retarder (FIG. 1, RM-BC00), disclosed embodiments found that the addition of the retarder caused a decrease in the relative proportion of the fully dissociated silicate species)(Q⁰) with other types of silicate species. Apparently, barium cations interact with silicate species to a certain extent resulting by increasing polymerization of silicate species.

With increasing dosage of the retarder, the intensities of respective Raman bands decreased. When the retarder increased to 5% BWOB or 0.23 molar B/Si (FIG. 2), the respective Raman bands disappeared almost completely, indicating significant interactions between barium and silicate species were induced in the precipitated complex. Increased interactions at a higher dosage of barium chloride dihydrate may result in a significantly delayed release of silicate species and thus extend set times significantly while yielding a hardened geopolymer with lowered early strength.

### EXAMPLES

### Example Subject Matter

The following examples will illustrate the practice of the present disclosure in its preferred embodiments.

The following raw materials were used for preparing samples in the examples 1 to 21. Two fly ashes were used. One was a High-CaO FFA (12.5%) from Jewett Power Station, Texas, US, marketed by Headwater Resources (Jewett fly ash). This fly ash contains 12.2 wt. % CaO and has a Loss-On-Ignition (LOI) of 0.15%. Its sum of Si+Al+Fe oxides is 79.57 wt. %, which was greater than 75 wt. % that was the minimum requirement for Class F Fly ash according to ASTM C618. Second fly ash was a Low-Ca FFA from Neilsens Group, Australia. This FFA was as product of classification of coarser fly ash. It had an LOI of less than 0.15%. Its sum of Si+Al+Fe oxides is about 93 wt. %. Ground granulated blast furnace slag grade 120 (NewCem Slag cement) was from the Lafarge-Holcim's Sparrow Point plant in Baltimore, Md. Activity index was about 129 according to ASTM C989. The blast furnace slag contained about 38.5% CaO, 38.2% SiO₂, 10.3% Al₂O₃, and 9.2% MgO with a mean particle size of 13.8 μm and 50 vol % less than 7 μm. Metakaolin (Kaorock) was from Thiele Kaolin Company, Sandersville, Ga. The metakaolin had a particle size between 0.5 and 50 μm with 50 vol % less than 4 μm. Silica fume, an industrial waste product from Fe—Si alloying, was from Norchem Inc. The silica fume contained 2.42 wt. % carbon. The silica fume was used to prepare activator solutions by dissolving silica fume in alkali hydroxide solution, or added as submicron reactive filler in preparing ultrahigh performance concrete samples.

Bluestone #7 (AASHTO T-27) was used as coarse aggregate. To reach a saturated surface dry (SSD) condition, the dry aggregate was immersed in water for 24 hours, and then the free water was manually removed from the aggregate surface using a dry cloth. River sands either in SSD or oven dry condition was used. A Trident moisture probe (model T90) was used to determine the moisture content of a fine aggregate sample. A Min U-SIL® crushed quartz powder from U.S. Silica was used to prepare ultrahigh performance concrete. The quartz powders have a particle size between 1 to 25 μm with a median diameter of about 5 μm.

Type Ru sodium silicate solution from PQ, Corp was used to prepare alkali silicate activator solution. The mass ratio of SiO₂/Na₂O was about 2.40. The solution as received contains about 13.9 wt. % Na₂O, 33.2 wt. % SiO₂ and 52.9 wt. % water. Sodium hydroxide beads (99% purity) and potassium hydroxide flakes (91% purity) were used for preparing alkali activator solution.

### Examples 1 to 7

Geopolymer samples with high-Ca Class F fly ash from Jewett Power Station, Texas, USA were prepared. The mix compositions were shown in Table 3 and ingredients were shown in grams. The batch size was about 5000 grams. The Jewett fly ash contained about 12.2 wt. % CaO. The geopolymer samples from Example #1 and 2 were prepared with the retarder sodium hexa-metaphosphate (SHMP) for a comparison. Sodium phosphate was disclosed in prior art or in the literature as a retarder. The dosage of SHMP was 1.50% and 2.25% BWOB, respectviely. The geopolymer samples from Example #4 to #7 were prepared with the retarder barium chlorie dihydrate at dosages of 0.50% to 1.00 wt. % BWOB to demonstrate the efficiency of retading.

NaOH beads (99% purity) were dissolved in water and the resulting solution was then combined with Type Ru sodium silicate solution to prepare the activator solution. Barium chloride dihydrate or sodium metaphosphate (SHMP) was dissolved in water separatly to prepare a retarder solution. The retarder solution was mixed for 2 hours and then poured into Jewett fly ash in a high intensive K-Lab mixer (Kercher Industries) for 6 minutes. The obtained fresh pastes were immediately transferred into molds (3″ high and 40 mm high), followed by treating on a vibrating table for about 1 minute to remove entrapped air bubbles. The fresh pastes were determined for initial and final set times with a Vicatronic Automatic Vicat instrument (Model E004N), hereafter called AutoVicat according to ASTM C191.

TABLE 3

| | | | | | | Barium | | Set time | |
|---|---|---|---|---|---|---|---|---|---|
| | Sample | Sodium | Sodium | | Fly | chloride | | (minutes) | |
| Example# | ID | silicate | hydroxide | Water | ash | dihydrate | SHMP | Initial | Final |
| #1 | MP1.50 | 579.0 | 98.3 | 672.9 | 3650.9 | 0 | 54.8 | 35 | 57 |
| #2 | MP2.25 | 579.0 | 98.3 | 672.9 | 3650.9 | 0 | 82.1 | 38 | 63 |
| #3 | BC0.00 | 579.0 | 98.3 | 672.9 | 3650.9 | 0 | 0 | 29 | 45 |
| #4 | BC0.50 | 579.0 | 98.3 | 672.9 | 3650.9 | 18.4 | 0 | 47 | 78 |
| #5 | BC0.75 | 579.0 | 98.3 | 672.9 | 3650.9 | 27.7 | 0 | 68 | 99 |
| #6 | BC0.875 | 579.0 | 98.3 | 672.9 | 3650.9 | 32.3 | 0 | 114 | 144 |
| #7 | BC1.00 | 579.0 | 98.3 | 672.9 | 3650.9 | 36.9 | 0 | 391 | 450 |

The initial set time for the control sample (Example 3, BC00) was determined to be 29 minutes and the final set time was 45 minutes. Adding 0.50% BWOB of barium chloride dihydrate, the initial set time was increased to 47 minutes and the final set time to 78 minutes (Example 4). Increasing barium chloride dihydrate to 0.75% BWOB, the initial set time was increased to 68 minutes and the final set time to 99 minutes (Example 5). Increasing barium chloride dihydrate to 0.875% BWOB, the initial set time was increased to 114 minutes and the final set time to 144 minutes (Example 6). Further increasing barium chloride dihydrate to 1% BWOB, the initial set time was increased to 391 minutes and the final set time to 450 minutes (Example 7). The isothermal calorimetry data revealed that adding of the retarder significantly reduce heat of hydration of the geopolymers.

As a comparison, doping with 1.5% BWOB of sodium metaphosphate, the initial set time was 35 minutes and final set time was 57 minutes. Increasing sodium metaphosphate to 2.25% BWOB, the initial set time was slightly increased to 38 minutes and the final set time to 63 minutes. Apparently, the present retarder is much more efficient than the retarder disclosed in the prior art or in the literature.

### Examples 8 to 10

To prepare the binary FFA/BFS geopolymer mortar samples with mix compositions shown in Table 4. The ingredients were shown in grams. Low-Ca Class F fly ash from Neilsens Concrete, Australia, ground granulated blast furnace slag from Lafarge-Holcim, and rivers sand (saturated surface dry) were mixed for 3 minutes in a Waring 7 quart planetary mixer. NaOH beads were dissolved in water and the resulting solution was then combined with Type Ru sodium silicate solution to prepare the activator solution. The activator solution was left overnigh before use. Barium chloride dihydrate if any was dissolved in water separately. The dosage of the retarder was fixed at 0.875% BWOB.

The activator solution without barium chloride dihydrate (Example #8) was poured into the FFA/BFS/sand mixture and mixed for 5 minutes at an intermediate speed. The fresh mortar was measured for set times with an AutoVicat accordimng to ASTM C191. The initial set time was 114 minutes and the final set time was 186 minutes.

The retarder solution was mixed with the activator solution for 30 minutes before preparing the geopolymer mortar sample (Example 9). The fresh mortar was measured for set times with an AutoVicat accordimng to ASTM C191. The initial set time was 249 minutes and the final set time was 348 minutes.

The retarder solution was added at the time the activator solution was poured to the dry ingredient mixture (Example 10). The mixture was mixed for 5 minutes. The fresh mortar was measured for set times with an AutoVicat accordimng to ASTM C191. The initial set time was 236 minutes and the final set time was 342 minutes.

TABLE 4

| | | | | | | | Barium | Set time | |
|---|---|---|---|---|---|---|---|---|---|
| Example | Sodium | Sodium | | | | River | chloride | (min) | |
| # | silicate | hydroxide | Water | FFA | BFS | sand | dihydrate | Initial | Final |
| #8 | 252.3 | 49.23 | 268.2 | 714.1 | 178.5 | 1450.8 | 0 | 114 | 186 |
| #9 | 252.3 | 49.23 | 268.2 | 714.1 | 178.5 | 1450.8 | 7.59 | 236 | 342 |
| #10 | 252.3 | 49.23 | 268.2 | 714.1 | 178.5 | 1450.8 | 7.59 | 249 | 348 |

### Examples 11 to 13

To prepare the binary FFA/BFS geopolymer mortar samples with the same mix composition employed in Examples 8 to 10 (Table 4). Low-Ca Class F fly ash from Neilsens Group, Australia, ground granulated blast furnace slag from Wagners, Australia, and rivers sand (saturated surface dry) were mixed for 3 minutes in a Waring 7 quart planetary mixer. NaOH beads were dissolved in water and the resulting solution was then combined with Type Ru sodium silicate solution to prepare the activator solution. The activator solution was left overnigh before use. Barium chloride dihydrate if any was dissolved in water separately. The dosage of the retarder was fixed at 1.25% BWOB.

The activator solution without barium chloride dihydrate (Example #11) was poured into the FFA/BFS/sand mixture and mixed for 5 minutes at an intermediate speed. The fresh mortar was measured for set times with an AutoVicat according to ASTM C191. The initial set time was 59 minutes and the final set time was 144 minutes. The compressive strength was 4081 psi after curing for 7 days and was increased to 8032 psi after curing for 28 days.

The retarder solution was mixed with the activator solution for 30 minutes before preparing the geopolymer mortar sample (Example 12). The fresh mortar was measured for set times with an AutoVicat accordimng to ASTM C191. The initial set time was 136 minutes and the final set time was 198 minutes. The compressive strength was 3673 psi after curing for 7 days and increased to 7734 psi after curing for 28 days.

The retarder solution was added at the time the activator solution was poured to the dry ingredient mixture (Example 13). The mixture was mixed for 5 minutes. The fresh mortar was measured for set times with an AutoVicat accordimng to ASTM C191. The initial set time was 114 minutes and the final set time was 180 minutes. The compressive strength was 4064 psi after curing for 7 days and increased to 7970 psi after curing for 28 days.

### Examples 14 to 16

To prepare geopolymeric ultrahigh performance concrete (GUHPC), metakaolin (5.71 wt. %) and ground granulated blast furnace slag (14.72 wt. %) were mixed in a high intensive mixer (K-Lab, Kercher Industries). An activator was prepared by mixing Na₂O (2.12 wt. %) as NaOH, K₂O (1.35 qt % wt. %) as KOH, SiO₂ (3.95 wt. %) as Type Ru sodium silicate solution, and water (10.15 wt. %). Barium chloride dihydrate if any was dissolved in water separately and then combined with the activator solution 5 minutes before preparing the samples. The activator solution was then poured into the MK/BFS blend and mixed for 3 minutes at about 350 rpm. Then dry river sand (50 wt. %) and quartz powder (10.00 wt. %) were added to the mixture and continued mixed for 3 minutes. Toward ending of mixing, silica fume (2.00%) was added and continued mixing for 3 minutes. The resulting paste was determined for initial set time with an AutoVicat or with a manual Vicat device. The paste was poured into 2″×4″ cylindrical molds and cured at room temperature. Compressive strength was measured after curing for 28 days on a Test Mark CM-4000-SD compression. The compression machine was calibrated against the NIST Traceable standards.

Without barium chloride dihydrate (Example 14), the initial set time was estimated about 30 minutes and the compressive strength was about 19972 psi after curing for 28 days. When 1 wt. % BWOB of barium chloride dihydrate was added (Example 15), the initial set time was 54 minutes and the compressive strength was about 20146 psi after curing for 28 days. When 2 wt. % BWOB of barium chloride dihydrate was added (Example 16), the initial set time increased to 89 minutes and the compressive strength was about 19424 psi after curing for 28 days.

### Examples 17 to 18

To prepare GUHPC samples, metakaolin (5.92 wt. %) and ground granulated blast furnace slag (15.28 wt. %) were mixed in a high intensive mixer (K-Lab, Kercher Industries). An activator was prepared by mixing Na₂O (1.08 wt. %) as NaOH, K₂O (2.47 qt % wt. %) as KOH, SiO₂ (3.80 wt. %) as silica fume, and water (9.45 wt. %). Silica fume was dissolved in the alkali hydroxide solution and the resulting activator solution was aged for a week before use. Barium chloride dihydrate if any was dissolved in water separately and then combined with the activator solution 10 minutes before preparing the samples. The activator solution was then poured into the MK/BFS blend and mixed for 3 minutes at about 350 rpm. Then dry river sand (50 wt. %) and quartz powder (10.00 wt. %) were added to the mixture and continued mixing for 3 minutes. Toward ending of mixing, silica fume (2.00%) was added and continued mixing for 3 minutes. The resulting paste was determined for initial and final set times with a manual Vicat device. The paste was poured into 2″×4″ cylindrical molds and cured at room temperature. Compressive strength was measured after curing for 28 days.

Without barium chloride dihydrate (Example 17), the initial set time was 15 minutes, the final set time was 19 minutes, and the compressive strength was about 26418 psi after curing for 28 days. When 1.5 wt. % BWOB of barium chloride dihydrate was added (Example 18), the initial set time was 73 minutes, the final set time was 81 minutes, and the compressive strength was about 23817 psi after curing for 28 days.

### Examples 19 to 20

Examples 19 and 20 demonstrate the efficiency in control of setting using a soluble barium salt in geopolymer concretes.

The mix composition for both concrete samples contained 78.75 wt. % aggregates with the mass ratio of coarse to fine of 1.74. The binder contained 80% of Low-CaO FFA and 20% of blast furnace slag. The w/b ratio was 0.47, molar NaOH concentration was 5.7 and mass ratio of SiO₂/Na₂O was 1.15 for the activator solution. To prepare geopolymer concrete samples, the Low-CaO FFA from Neilsens Group, Australia, blast furnace slag from Lafarge-Holcim, and river sand (SSD condition) were mixed for 3 minutes in a high intensive mixer (K-Lab, Kercher Industries). NaOH beads were dissolved in water and the resulting solution was then combined with Type Ru sodium silicate solution to prepare the activator solution. The activator solution was left overnigh before use.

The activator solution without retarder (Example #19) was poured into the FFA/BFS/sand mixture and mixed for 3 minutes at 300 rpm. Then SSD coarse aggregate (Grade #7) was added and mixed for 5 minutes at a low mixing speed (e.g., 20 rpm). The fresh concrete was sieved to obtain mortar sample that was measured with an Acme Penetrometer for set times according to ASTM C403. The fresh concrete was also poured into 3″×6″ cylidrical moulds and vibrated for 1 minute on a vibratio table. The samples were capped on and cured at room temperatures until compressive strength was measured. The initial set time was 75 minutes and the final set time was 168 minutes. The compressive strength after curing for 7 days was 4509 psi and increased to 7992 psi after curing for 28 days.

Using the same procedure described in Example 19, additional concrete samples with a retarder were prepared (Example 20). Barium chloride dihydrate was dissolved in water separately. The dosage of retarder was 1.00% BWOB. The retarder solution was mixed for 30 minutes with the activator solution before preparing fresh concrete sample. The fresh concrete was sieved to obtain mortar sample for set times with an Acme Penetrometer according to ASTM C403. The initial set time was 313 minutes and the final set time was 572 minutes. The compressive strength was 3707 psi after curing for 7 days and 7259 psi after curing for 28 days.

### Example 21

The same mix composition without the retarder solution as in Example #8 was mixed for 30 min and then the retarder solution (3% barium chloride BWOB) was poured into the paste while mixing and was additionally mixed for 10 min. After mixing was stopped, the mortar sample was subject to ASTM C191 for set time determination. At about 7.4 hours after pouring the activator solution into the dry mixture, the mortar sample did not show any sign of setting, indicating that the retarder did delay setting efficiently. The retarder can be used for emergency set brake of a fresh geopolymer concrete that is in transportation in a ready mix truck.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### REFERENCES

The following references are referred to above and are incorporated herein by reference:
1. D. M. Roy, G. M. Idor, “Hydration, Structure, and Properties of Blast Furnace Slag Cements, Mortars, and Concrete,” ACI Materials Journal 79 (1982) pp. 444-457.
2. S. D. Wang, X. C. Pu, K. L. Scrivener, P. L. Pratt, “Alkali-activated Slag Cement and Concrete: A Review of Properties and Problems,” Advance in Cement Research 27 (1995) pp. 93-102.
3. J. L. Provis, J. S. J. van Deventer, “Alkali Activated Materials.” Springer: Houten, The Netherlands, 2014.
4. E. I. Diaz, E. N. Allouche, S. Eklund, “Factors Affecting the Suitability of Fly Ash as Source Material for Geopolymers,” Fuel 89 (2010) pp. 992-999.
5. E. I. Diaz-Loya, E. N. Allouche, and S. Vaidya, “Mechanical Properties of Fly-Ash-Based Geopolymer Concrete,” ACI Materials Journal 108 (2011) pp. 300-306.
6. P. Topark-Ngarm, P. Chindaprasirt, and V. Sata, Setting Time, “Strength, and Bond of High-Calcium Fly Ash Geopolymer Concrete,” Journal of Materials in Civil Engineering 27 (2015).
7. L. Kalina, V. BIlek Jr., R. Novotny, M. Mončeková, J. Másilko and J. Koplík, “Effect of Na₃PO₄ on the Hydration Process of Alkali-Activated Blast Furnace Slag,” Materials 9 (2016) pp. 395-403.
8. J. J. Chang, “A Study on the Setting Characteristics of Sodium Silicate-activated Slag Pastes,” Cement and Concrete Research 33 (2003) pp. 1005-1011.
9. J. J. Chang, W. C. Yeih, C. C. Hung, “Effects of Gypsum and Phosphoric Acid on the Properties of Sodium Silicate-based Alkali-activated Slag Pastes,” Cement and Concrete Composites 27 (2005) pp. 85-91.
10. C. Wu, Y. Zhang, Z. Hu, “Properties and Application of Alkali-slag Cement,” Journal of the Chinese Ceramic Society 21 (1993) pp. 175-181.
11. U. Rattanasak, K. Pankhet, P. Chindaprasirt, “Effect of Chemical Admixtures on Properties of High-calcium Fly Ash Geopolymer,” International Journal of Minerals Metallurgy and Materials 18 (2011) pp. 364-369
12. A. R Brough, M. Holloway, J. Sykes, A. Atkinson, “Sodium silicate-based alkali-activated slag mortars: Part II. The retarding effect of additions of sodium chloride or malic acid,” Cement and Concrete Research 30 (2000) pp. 1375-1379.
13. A. R. Sakulich, E. Anderson, C. Schauer, M. W. Barsoum, “Mechanical and Microstructural Characterization of an Alkali-activated Slag/Limestone Fine Aggregate Concrete,” Construction and Building Materials 23 (2009) pp. 2951-2957.
14. C. L. Nicholson, B. J. Murray, R. A. Fletcher, D. Brew, K. J. Mackenzie, M. Schmücker, “Novel Geopolymer Materials Containing Borate Structural Units. In Proceedings of the World Congress Geopolymer,” Perth, Australia, September 2005; pp. 31-33.
15. M. Davraz, “The Effects of Boron Compounds on the Properties of Cementitious Composites,” Science and Engineering of Composite Materials 17 (2010) pp. 1-18.
16. G. R. Qian, D. D. Sun, J. H. Tay, “Characterization of mercury- and zinc-doped alkali-activated slag matrix Part II. Zinc,” Cement and Concrete Research 33 (2003) pp. 1257-1262.
17. G. R. Qian, D. D. Sun, J. H. Tay, “Immobilization of Mercury and Zinc in an Alkali-activated Slag Matrix,” Journal of Hazardous Materials B101 (2003) 65-77.
18. W. L. Gong, H. Xu, W. Lutze, I. L. Pegg, “Pumpable Geopolymer Compositions for Well Sealing Applications,” U.S. patent application Ser. No. 15/597,227, filed May 17, 2017, pending (2016).
19. I. Halasz, M. Agarwal, R. B. Li, N. Miller, “What Can Vibrational Spectroscopy Tell about the Structure of Dissolved Sodium Silicates?” Microporous and Mesoporous Materials 135 (2010) pp. 74-81.
20. I. Halasz, M. Agarwal, R. B. Li, N. Miller, “Vibrational Spectra and Dissociation of Aqueous Na₂SiO₃ Solutions,” Catalysis Letters 117 (2007) pp. 34-42.

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. A geopolymer composition having a controllable setting time comprising:
at least one reactive aluminosilicate;
at least one retarder; and
at least one alkali silicate activator solution.

2. The geopolymer composition of claim 1, wherein the at least one reactive aluminosilicate comprises Low-Ca Class F fly ash (FFA) and blast furnace slag (BFS).

3. The geopolymer composition of claim 2, wherein the Low-Ca Class F fly ash (FFA) is fly ash which comprises less than or equal to about 8 wt. % of calcium oxide.

4. The geopolymer composition of claim 3, wherein the fly ash contains at least 65 wt. % amorphous aluminosilicate phase.

5. The geopolymer composition of claim 3, wherein the fly ash has a mean particle diameter of one of: 60 μm or less, 50 μm or less, 45 μm or less and 30 μm or less.

6. The geopolymer composition of claim 2, wherein the Low-Ca Class F fly ash (FFA) has a Loss On Ignition (LOI) less than or equal to 5%.

7. The geopolymer composition of claim 2, wherein the at least one reactive aluminosilicate further comprises metakaolin (MK).

8. The geopolymer composition of claim 1, wherein the at least one reactive aluminosilicate comprises at least one High-Ca aluminosilicate selected from the group: High-Ca Class F fly ash (FFA), Class C fly ash (CFA), blast furnace slag (BFS), vitreous calcium silicate (VCAS), bottom ash, and clinker kiln dust (CKD).

9. The geopolymer composition of claim 8, wherein the at least one reactive aluminosilicate further comprises metakaolin (MK).

10. The geopolymer composition of claim 1, wherein the at least one reactive aluminosilicate comprises blast furnace slag (BFS) and metakaolin (MK).

11. The geopolymer composition of claim 1, wherein the at least one reactive aluminosilicate comprises Class C fly ash (CFA) and metakaolin (MK).

12. The geopolymer composition of claim 1, wherein the alkali silicate activator solution comprises metal hydroxides and metal silicates and wherein the metal is potassium, sodium or combinations of both.

13. The geopolymer composition of claim 1, wherein the at least one retarder is a soluble metal salt that hydrolyzes in the alkaline solution and co-precipitates silicate species present in the alkali silicate activator solution.

14. The geopolymer composition of claim 13, wherein the metal salt is selected from the group: barium chloride anhydrous, barium chloride dihydrate, barium nitrate, barium nitrite, barium metaborate monohydrate, zinc nitrate, zinc chloride, zinc sulfate, lead chloride, lead nitrate, strontium chloride, strontium nitrate, and strontium sulfate.

15. The geopolymer composition of claim 1, wherein the at least one retarder is selected from the group: barium chloride anhydrous, barium chloride dihydrate, barium nitrate, barium nitrite, and barium metaborate monohydrate.

16. The geopolymer composition of claim 1, wherein the at least one retarder is used in the amount of about 0.1 to about 10% BWOB and more preferably from about 0.25 to about 5 wt. % BWOB.

17. The geopolymer composition of claim 1, wherein the geopolymer composition further comprises at least one aggregate.

18. The geopolymer composition of claim 1, wherein the geopolymer composition further comprises at least one micron- or sub-micron filler.

19. The geopolymer composition of claim 1, wherein the at least one retarder is dissolved in water and combined with the at least one alkali silicate activator solution before mixing with other ingredients to manufacture geopolymer products.

20. The geopolymer composition of claim 1, wherein the at least one retarder is dissolved in water to form a retarder solution, and wherein the retarder solution is added together with the at least one alkali silicate activator solution at the time of mixing with other ingredients to manufacture geopolymer products.

21. The geopolymer composition of claim 1, wherein the at least one retarder is dissolved in water to form a retarder solution, and wherein the retarder solution is added after mixing the activator solution with dry ingredients.

22. The geopolymer composition of claim 1, wherein an initial setting time is from about 25 minutes to about 24 hours.

23. The geopolymer composition of claim 1, wherein an initial setting time is from about 45 minutes to about 180 minutes.

24. The geopolymer composition of claim 1, wherein an initial setting time is from about 90 minutes to about 360 minutes.

25. A method of making a geopolymer composition having a controllable setting time comprising:
combining at least one reactive aluminosilicate, at least one retarder and at least one alkali silicate activator solution.

26. The method of claim 25, wherein the at least one reactive aluminosilicate comprises Low-Ca Class F fly ash (FFA) and blast furnace slag (BFS).

27. The method of claim 26, wherein, the Low-Ca Class F fly ash (FFA) is fly ash which comprises less than or equal to about 8 wt. % of calcium oxide.

28. The method of claim 26, wherein the at least one reactive aluminosilicate further comprises metakaolin (MK).

29. The method of claim 25, wherein the at least one reactive aluminosilicate comprises at least one High-Ca aluminosilicate selected from the group: High-Ca Class F fly ash (FFA), Class C fly ash (CFA), blast furnace slag (BFS), vitreous calcium silicate (VCAS), bottom ash, and clinker kiln dust (CKD).

30. The method of claim 29, wherein the at least one reactive aluminosilicate further comprises metakaolin (MK).

31. The method of claim 25, wherein the at least one reactive aluminosilicate comprises blast furnace slag (BFS) and metakaolin (MK).

32. The method of claim 25, wherein the at least one reactive aluminosilicate comprises Class C fly ash (CFA) and metakaolin (MK).

33. The method of claim 25, wherein the retarder comprises a retarder solution made by dissolving a soluble metal salt in water.

34. The method of claim 33, wherein the soluble metals salt is selected from one of barium chloride, barium chloride dehydrate, barium nitrate, barium nitrite, barium metaborate monohydrate, barium nitrate hydrate, zinc nitrate, zinc chloride, zinc sulfate, strontium chloride, strontium nitrate and strontium sulfate.

35. The method of claim 33, wherein the retarder solution is mixed with the alkali silicate activator solution before mixing with all other ingredients.

36. The method of claim 25, wherein the retarder solution and the alkali silicate activator solution are added separately at the time when mixing with all other ingredients.

37. The method of claim 25, wherein the retarder solution is mixed with the alkali silicate activator solution for one of approximately 10 minutes, 30 minutes, and 24 hours before mixing with all other ingredients.
